(19) United States
(12) Patent Application Publication
(10) Pub. No.: US 2011/0061112 A1
(43) Pub. Date: Mar. 10, 2011

(54) SYSTEM AND METHOD FOR ENFORCING DATA ENCRYPTION ON REMOVABLE MEDIA DEVICES

(76) Inventors: Pavel Berengoltz, Petah-Tikva (IL); Hay Hazama, Kiryat Ono (IL); On Freund, Savyon (IL)

(21) Appl. No.: 12/922,431

(22) PCT Filed: Mar. 12, 2009
(86) PCT No.: PCT/IL09/00281

§ 371 Date: Nov. 23, 2010

Related U.S. Application Data
(60) Provisional application No. 61/035,808, filed on Mar. 12, 2008.

(51) Int. Cl. G06F 21/24

(52) U.S. Cl. 726/30

(57) ABSTRACT

A system and method of enforcing encryption of information is provided. An information or content parameters list may be associated with a repository of information and may be updated to reflect information stored in said repository. A hash parameter may be computed and may further be used to validate integrity of information stored in the repository. At least one parameter identifying an entity storing information from said repository on a designated device may be used in order to determine that the entity is storing information obtained from said repository. Other embodiments are described and claimed.

### BACKGROUND OF THE INVENTION

A large and increasing portion of the information handled in today's modern office environment is digital. Many organizations, institutions and establishments store, handle and manipulate most of their information, and/or information associated with their activities, in digital forms. In many cases, such information may include confidential, secret or otherwise sensitive information, which, in the wrong hands, may cause serious damage to the owner or keeper of the information and/or to those associated with the owner or keeper of the information. Uncontrolled information flow is a recognized problem in various industries, organizations and environments. For example, commercial organizations, government agencies, academic institutions and/or health care facilities may all be at risk of sensitive information being provided to unauthorized, possibly hostile entities.

Much attention has been devoted to devising methods for preventing sensitive information from being provided to unauthorized entities, for example by encrypting the information. However, inspecting information being burned onto a writable media such as a read/write compact disk may interfere with device and/or operating system's constraints and/or may jeopardize stability and/or data integrity.

There is a need for a system and/or method to enable users to conveniently copy sensitive information to removable and/or detachable storage devices while at the same time enforcing a security policy such as encrypting information being copied.

### SUMMARY OF EMBODIMENTS OF THE INVENTION

According to embodiments of the invention, information to be stored on a removable or detachable device may be encrypted and stored in a dedicated information repository. According to embodiments of the invention, such information repository may be associated with a cross reference list referencing information objects stored in the information repository. According to embodiments of the invention, transferring information from the information repository to a designated device may be performed according to information contained in said list. According to embodiments of the invention, storing information on a designated device may comprise determining that an entity performing the storage obtains the information being stored from a designated information repository.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a schematic block diagram according to embodiments of the invention; and

FIG. 2 is a schematic flow chart according to embodiments of the invention; and

FIG. 3 is a schematic flow chart according to embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Unless explicitly stated, the method embodiments described herein are not constrained to a particular order or sequence. Additionally, some of the described method embodiments or elements thereof can occur or be performed at the same point in time.

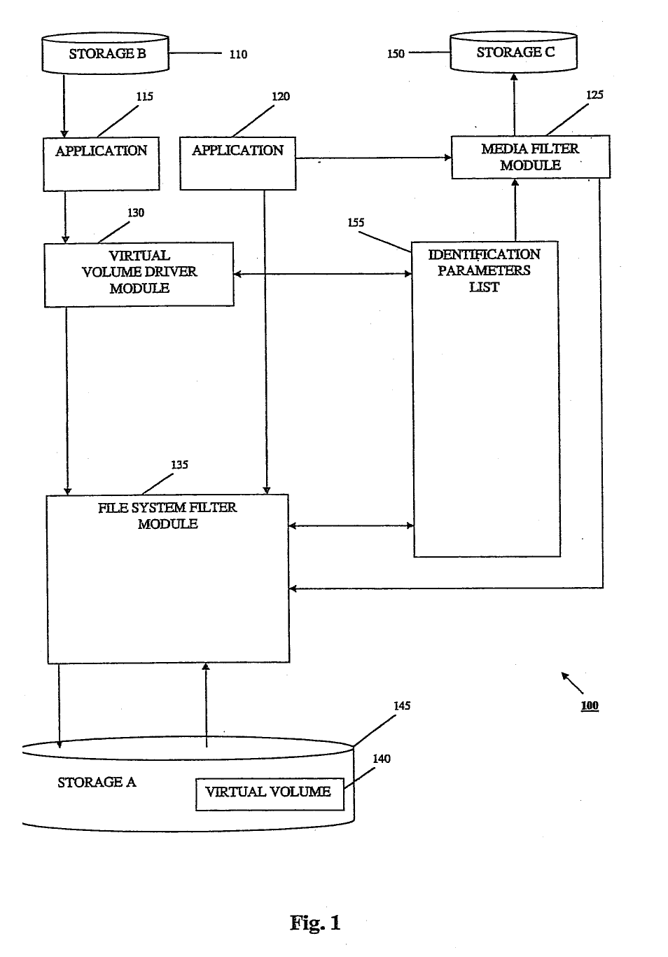

Reference is made to FIG. 1 showing exemplary components of exemplary system 100 according to embodiments of the invention. According to embodiments of the invention, system 100 may comprise storage devices 110, 145 and 150. According to embodiments of the invention, system 100 may further comprise file system filter 135, virtual volume driver module 130, a virtual volume 140, media filter module 125, information parameters list 155, and applications 115 and 120. The components listed above, their operational and/or functional aspects are described below.

According to embodiments of the invention, storage devices 110 and 145 may be internal or external hard drives or disks, or they may be a random access memory (RAM), a dynamic random access memory (DRAM), a RAM disk, a non-volatile storage chip, a removable storage media, universal serial bus (USB) storage device, network storage device, a FLASH storage device, backup storage or any other suitable storage device or media. According to embodiments of the invention, storage device 150 may be an optical media. For example, device 150 may be a write-once or rewritable optical media such as a compact disc (CD), a digital video disc DVD, a high definition (HD) DVD, or a Blue-Ray™ disk.

According to embodiments of the invention, virtual volume 140 may be implemented on storage device 145. As known in the art, defining a virtual volume or disk may comprise allocating a physical segment, e.g. specific sectors, of a storage device to a virtual file system or virtual volume. For example, a virtual volume may be contained in a regular file in a file system managed by an operating system. According to embodiments of the invention, any suitable information repository may be used instead of a virtual volume. According to embodiments of the invention, any repository enabling embodiments of the invention to store, retrieve, modify, delete or otherwise manipulate information may be used. The terms repository and virtual volume may be used interchangeably in this specification.

According to embodiments of the invention, a repository or virtual volume may further be formatted or otherwise manipulated by an application. For example, an application may format virtual volume 140 according to any, possibly proprietary and/or secret, convention, rules or logical view. Such formatting may comprise storing information in a file containing the repository or virtual volume, such information may define logical aspects pertaining to information objects in the repository or virtual volume. Accordingly, information stored in virtual volume 140 may be useless to any application or human unfamiliar with the convention or rules according to which virtual volume 140 is formatted. According to embodiments of the invention and as known in the art, virtual volume 140 may be presented to user mode applications as a virtual drive. Accordingly, an application may store information in volume 140 as if it were storing information in a disk drive. According to embodiments of the invention, direct access to information, storage of information or otherwise manipulating information in volume 140 may be coordinated, supervised, filtered or otherwise managed by file system filter module 135 and/or virtual volume driver module 130.

According to embodiments of the invention, an application wishing to access information in volume 140 or store information in volume 140 may do so by issuing a proper request to driver module 130. Accordingly, driver module 130 may perform operations associated with virtual volume 140 on behalf of an application. For example, an application may format virtual volume 140 by causing driver module 130 to write information to virtual volume 140. Such or other application may read information from virtual volume 140 by having driver module 130 read the information from volume 140 and further provide the application with the information. Accordingly, writing information to virtual volume 140 may be done by driver 130 on behalf of an application wishing to write information to virtual volume 140.

According to embodiments of the invention, file system filter module 135 may deny access to information stored in virtual volume 140 or deny storage of information in virtual volume 140. According to embodiments of the invention, filter 135 may monitor interactions with the file system containing virtual volume 140 and may further intercept attempts to access virtual volume 140. Such denial of access may be according to predefined rules, policies, conditions or other aspects that filter 135 may be configured to take into account upon detecting a request to read, write, delete or otherwise manipulate information in virtual disk 140. According to embodiments of the invention, file system filter module 135 may be configured to detect requests made to an operating system's file system and may further block operations as described above.

According to embodiments of the invention, filter 135 may prohibit any entity other than virtual volume driver module 130 from accessing virtual volume 140. According to embodiments of the invention, virtual volume driver module 130 may share a secret key with file system filter module 135 and may further use such secret key in order to gain access to volumes stored on storage device 145 such as virtual volume 140. For example, a paradigm where by virtual volume driver module 130 may provide file system filter module 135 with a certificate may be followed. Such certificate may be pre-configured to be provided and accepted by driver module 130 and filter 135 respectively. Accordingly, possibly after identifying driver module 130 by a known certificate, file system filter module 135 may provide driver module 130 with some secret key, parameter, code or other information. According to embodiments of the invention, file system filter module 135 may only grant access to virtual volume 140 upon being provided with the secret key or parameter. Such configuration may enable embodiments of the invention to allow access to content stored in virtual volume 140 to virtual volume driver module 130 only. Accordingly, such configuration may disable any other application or entity from manipulating content stored in virtual volume 140. It will be recognized that any other suitable way for enabling filter 135 to identify driver module 130 may be used without departing from the scope of the invention. For example, a file handle provided to driver module 130 upon an initial open of a file containing virtual volume 140 may be used as well as any other applicable information and/or parameter.

According to embodiments of the invention, virtual volume driver 130 may create virtual volume 140. According to embodiments of the invention, driver module 135 may create a file in a file system on storage device 145 and may further enable an application to format the file created as described above. According to embodiments of the invention, driver 135 may further compute a hash value based on the content of the newly created file containing virtual volume 140. According to embodiments of the invention, such hash value may be based on the file name and may further reflect, possibly in a cryptographic manner, the amount and/or other aspects of information stored in the file and consequently, the repository or virtual volume. According to embodiments of the invention, such hash value may be stored in a secured, possibly protected location. Such location may be any appropriate storage, possibly other than storage device 145. For example, the hash parameter may be stored on a removable storage device such as a USB storage device. Such configuration may enhance protection of information stored in virtual volume 140 by requiring an installment of, or an accessibility to, a storage device containing the hash value in order to access information stored in virtual volume 140. According to embodiments of the invention, access to the hash parameter may be restricted to designated entities. For example, access to the hash parameter may be permitted to authorized entities such as file system filter module 135, virtual volume driver 130 and/or filter module 125.

According to embodiments of the invention, driver module 135 may recalculate the hash value whenever the content stored in repository or virtual volume is modified. Accordingly, the hash value may be used by embodiments of the invention in order to determine that the content stored in virtual volume 140 has not been modified by any entity other than driver module 130. For example, a user may cause a computer hosting storage device 145 to boot from an alternative operating system (e.g., an operating system stored on some removable device) and may further add content to virtual volume 140. However, such user may not be able to properly modify the hash value associated with virtual volume 140. As described above, the hash value or parameter may be calculated according to various cryptographic methods that may be unknown to a malicious user. Alternatively, as described above, the hash value may be physically unavailable as it may be stored on a removable device and may be in the possession of an authorized user and consequently unavailable to unauthorized user.

According to embodiments of the invention, possibly in addition to recalculating the hash parameter as described above, file system filter driver module 135 and virtual volume driver module 130 may further update information parameters list 155. According to embodiments of the invention, list 155 may contain information pertaining to information objects stored in virtual volume 140 as well as metadata pertaining to or associated with virtual volume 140. For example, list 155 may contain information such as names, size and/or any other attributes or aspects associated with information or content objects contained in virtual volume 140, information pertaining to virtual volume 140 contained in list 155 may be the virtual volume name, size, modification date and/or any other applicable information. Accordingly, drivers 130 and 135 may update list 155 whenever content in a repository or virtual volume is modified. As will be described below, list 155 may be used during a burning process in order to verify the content of virtual volume 140. According to embodiments of the invention, information stored in list 155 may be encrypted or otherwise obfuscated. Accordingly, information stored in list 155 may only be accessed by designated, authorized entities such as driver module 135 or filter module 125.

According to embodiments of the invention, an application such as application 115 may read information from storage device 110 or storage device 140 and may further add such information to virtual volume 140. According to embodiments of the invention and as described above, driver module 130 and other, possibly operating system components, may provide application 115 with a virtual drive view representing virtual volume 140. Accordingly, application 115 may store information in the presented virtual drive, effectively providing the information to driver module 130. As described above, driver module 130 may negotiate access to virtual volume 140 with file system 135. Possibly after gaining permission to access virtual volume 140, driver module 130 may store information therein and cause driver 135 to recalculate the hash parameter to reflect the change in virtual volume 140. Driver module 135 may further store the newly calculated hash parameter in a designated location and may further update list 155 to reflect the changes made to volume 140. It will be recognized that other methods for modifying information in virtual volume 140 and further maintaining track of such modifications may be employed by embodiments of the invention. Alternatively, other methods for maintaining coherency between a hash parameter, list 155 and information stored in virtual volume 140 may be employed without departing from the scope of the invention.

According to embodiments of the invention, upon booting a computing device hosting a repository or virtual volume such as virtual volume 140 a verification of information integrity may be performed, possibly at the time volume 140 is first accessed following a boot or reset of the hosting device. According to embodiments of the invention, a hash parameter may be calculated upon boot of the hosting device and the calculated hash parameter may be further compared to a stored hash parameter. According to embodiments of the invention, if the calculated hash parameter does not match the stored parameter then it may be deduced that data integrity in virtual volume 140 has been jeopardized, accordingly, embodiments of the invention may disable access to virtual volume 140 to any application or user other than a designated, possibly privileged user. Additionally, if a discrepancy is detected as described, embodiments of the invention may prevent copying, duplicating or otherwise transferring content from virtual volume 140 to any storage device or, for example, burning content stored in virtual volume 140 on an optical media. A verification procedure as described above may disable modifying content stored in virtual volume 140 by any entity other than module 130.

As described above, media 150 may be an optical media. Application 120 may be a burning application capable of burning information on an optical media. According to embodiments of the invention, application 120 may read virtual volume 140 and may further attempt to burn such information onto media 150. According to embodiments of the invention, application 120 may access media 150 through an operating system driver. According to embodiments of the invention, media filter module 125 may intercept requests made to such driver. According to embodiments of the invention, media filter module 125 may extract metadata pertaining to content being written to device or media 150. For example, media filter module may extract information such as file names, file sizes and/or any other applicable information. According to embodiments of the invention, media filter module 125 may verify information written to device or media 150 by determining that such information is according to list 155. According to embodiments of the invention, information from virtual volume 140 may only be written to media 150 if it is correctly and properly listed in list 155.

According to embodiments of the invention, if media filter module 125 determines that information being written to media 150 is not properly listed in list 155 then media filter module 125 may interrupt a writing or burning process and possibly provide a user with an appropriate message or alert. According to embodiments of the invention, only information properly listed in list 155 may be copied or burned onto media 150. Such arrangement may prevent burning or copying of uncontrolled information to media 150. As described above, According to embodiments of the invention, information in virtual volume 140 may be encrypted, accordingly, by ensuring that only information properly added to virtual volume 140 may be copied onto media 150 embodiments of the invention may guarantee that only verified and encrypted information is copied to or burned onto media 150.

According to embodiments of the invention, upon detecting an attempt to write, copy, burn or otherwise transfer information to media 150, media filter module 125 may obtain an identification of the process, application or entity performing the attempt and may further communicate such information to file system filter module 135. According to embodiments of the invention, media filter module 125 may be configured to obtain such information from the operating system operating the computing device hosting storage device 145 and storage device or media 150. According to embodiments of the invention, information identifying the application, process, program or entity performing the write operation discussed may depend on various parameters, aspects and/or conditions. For example, such information may be a process identification or name and a thread identification.

According to embodiments of the invention, file system filter module 135 may verify that a process, application or any other entity transferring information to media 150 is only reading information from virtual volume 140. For example, filter 135 may use information provided to it by media filter module 125 in order to verify that a program burning data onto media 150 is not reading data from any other location or storage device other than virtual volume 140 on storage device 145. According to embodiments of the invention, filter 135 may intercept any access made by an identified program (e.g. a program corresponding to an identification provided by media filter module 125) to any file system on any storage device associated with the relevant computing device and may further cause a transfer of information to media 150 to be aborted if it discovers that such program is reading information from any location other than virtual volume 140. Such arrangement may enable embodiments of the invention to ascertain that only information from a designated location (e.g., a repository or virtual volume 140) is transferred to a specific location or device (e.g., media 150).

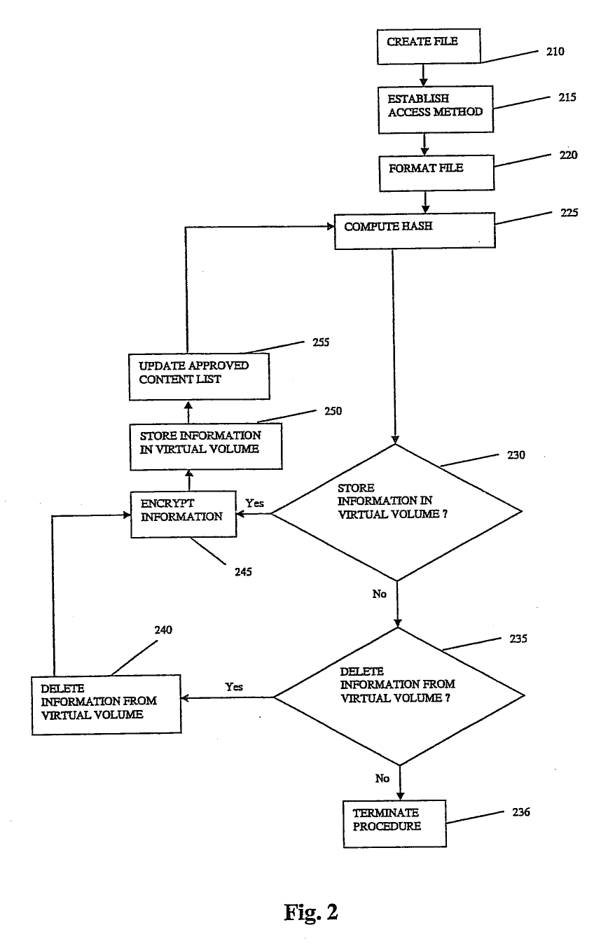

Reference is made to FIG. 2 showing an exemplary flow chart according to embodiments of the invention. According to embodiments of the invention and as indicated by block 210, the flow may include creating a file. Such file may be any suitable file, possibly created under a regular file system managed by any suitable operating system. According to embodiments of the invention, such file may be presented to upper layers as a virtual volume. For example, applications may be provided with a volume view of the file. Accordingly, applications may store information such as files in such virtual volume as if it were a regular volume, possibly supporting any applicable operations such as store and/or delete files. The file created as described above will be referred to as a virtual volume hereafter. According to embodiments of the invention, the naming convention used for selecting a name for the virtual volume may reflect various aspects pertaining to the virtual volume or may comprise various other parameters or information. For example, a signature may be added to the virtual volume's name or the size or amount of content that may be stored in the virtual volume may be used as a parameter for naming the virtual volume. According to embodiments of the invention, a naming convention may enable embodiments of the invention to verify various attributes, parameters or other information pertaining to the virtual volume. For example, the virtual volume's creation date, modify date or other time aspects may be reflected in the virtual volume's name. In other embodiments of the invention, an identification of the process, application, program or any other entity that last accessed the virtual volume may be reflected in the virtual volume name.

According to embodiments of the invention and as indicated by block 215, the flow may include establishing a method for accessing the virtual volume. According to embodiments of the invention and as described above, the virtual volume may be created by virtual volume driver module 130 (FIG. 1). According to embodiments of the invention, driver module 130 may exchange a parameter or other information with an entity managing the storage device containing the file created as described above. Such management entity may be a file system filter driver, a device driver, a file system management and/or interface or any other suitable combination of software, hardware and/or firmware that provides access and/or interface to information stored on a storage device containing the virtual volume. For example, a file system filter module may be configured to exchange an identification parameter with a creator of the virtual volume and may be further configured to intercept access to the virtual volume and verify the accessing entity is in possession of the above mentioned identification parameter. Such configuration may enable embodiments of the invention to only enable designated entities to access the virtual volume.

According to embodiments of the invention and as indicated by block 220, the flow may include formatting the virtual volume. According to embodiments of the invention, any formatting convention may be used to enable storing, retrieving, modifying or otherwise manipulating information stored in the virtual volume. For example, a file system may be defined and implemented within the virtual volume such that discrete files, information and/or content objects stored within the virtual volume may be readily manipulated. It will be recognized that any suitable formatting method or convention may be used without departing from the scope of the invention.

According to embodiments of the invention and as indicated by block 225, the flow may include computing a hash parameter. According to embodiments of the invention, a hash or any other suitable parameter may be computed. Such parameter may enable embodiments of the invention to verify an integrity of the information stored in the virtual volume. According to embodiments of the invention, a hash value may be calculated over an entire virtual volume, including unoccupied areas such as sectors or other physical segments or parts included or otherwise associated with a virtual volume such as virtual volume 140. Calculating a hash parameter as described may prevent a malicious application from using unoccupied sectors in a virtual volume in order to bypass security measures such as a hash parameter protection. According to embodiments of the invention, the parameter computed as shown by block 225 may be stored in a secured location. According to embodiments of the invention, the hash parameter may further be password or otherwise protected.

According to embodiments of the invention, the hash parameter may be stored on a removable device. Such configuration may enable a user to disable access to the virtual volume by detaching, removing, or otherwise making the removable device containing the hash parameter inaccessible. For example, a hash parameter may be stored on a USB storage device, such device may further be carried away from the computing device storing the virtual volume thus effectively making the virtual volume inaccessible. According to embodiments of the invention, when a computing device hosting an embodiment of the invention is booted a hash parameter may be computed for the virtual volume. According to embodiments of the invention, if the computed hash parameter does not match a stored hash parameter then according to embodiments of the invention access to the virtual volume may be disabled for any entity other than a designated, possibly administrative entity. Accordingly, detaching a device storing the hash parameter may cause the virtual volume to be inaccessible following a reboot. Alternatively, modifying the virtual volume without properly modifying the associated hash parameter may be detected by embodiments of the invention by comparing a computed hash parameter (that may take such modifications into account) to a stored, possibly previously computed hash parameter.

According to embodiments of the invention and as indicated by block 230, the flow may include checking if more data or information is to be stored in the virtual volume. For example, a application may store information such as files in the virtual volume. According to embodiments of the invention and as indicated by block 245, the flow may include encrypting data. For example, if it was determined as shown by block 230 that data is to be stored in the virtual volume then such data or information may be encrypted, possibly prior to being stored in the virtual volume. It will be noted that according to embodiments of the invention any suitable encryption may comprise of encoding, scrambling, reordering or otherwise relocating of bits, bytes, words, and/or sections or paragraphs comprising an information, data, document or content. Other examples of encryption may be data obfuscation or a changing of values of various elements comprising an information or content, for example according to a, possibly secret, pattern or key.

According to embodiments of the invention, an encryption method, key and/or any other aspects may vary from one segment of information stored in the virtual volume to another. For example, a first file stored in the virtual volume may be encrypted according to a first method, technique or means while a second file may be encrypted according to a second, possibly different method or technique. According to embodiments of the invention, information associating an encryption method with a specific information object may be embedded in the information, stored in the virtual volume or made available by other, possibly password or otherwise protected means. According to embodiments of the invention and as indicated by block 250, the flow may include storing of information in the virtual volume.

According to embodiments of the invention, encryption may be performed at any level. For example, encryption may be at a volume level, file level or physical sectors level. According to embodiments of the invention, all sectors comprising a virtual volume may be encrypted, including sectors containing no information, e.g., containing zeros. According to embodiments of the invention, possibly after a creation of a virtual volume or modifications to a virtual volume are made, relevant sectors may be encrypted. Consequently, a virtual volume stored on a disk may be encrypted at the physical sectors level. According to embodiments of the invention, encryption at the physical sector level may comprise encrypting metadata associated with and/or contained in a virtual volume. Such metadata may comprise files and/or folders names, sizes, modification times and/or any other applicable information or metadata that may be associated with a file or content object. Accordingly, a user or application may require a key, parameter or other information in order to able to perform any manipulations with regards to a virtual volume. For example, even a listing of files or other content objects stored in such virtual volume may only be made possible provided an encryption key is available.

According to embodiments of the invention, a single key may be used by the encryption process. Using a single key may enable a user or application provided with the key to decrypt information stored in the virtual volume.

According to embodiments of the invention and as indicated by block 255, the flow may include updating an information parameters list. According to embodiments of the invention, a list maintained may comprise volume name, last modification date, file size etc. For example, information, attributes and/or parameters such as name, size, creation date, modification date or any other applicable information pertaining to some or all information stored in a virtual volume may be stored in such list. According to embodiments of the invention, coherency between information stored in the virtual volume and the information parameters list may be preserved by embodiments of the invention as shown by block 225. According to embodiments of the invention and as indicated by block 225, possibly after storing information as described above, the flow may include re-computing of a hash parameter. Such computing may be performed as described above with reference to block 225.

According to embodiments of the invention and as indicated by block 235, possibly if no information is required to be added to or stored in the virtual volume, the flow may include checking if information is required to be deleted from the virtual volume. For example, an application may delete some or all of the content stored in the virtual volume, for example, if a planned burning of data on a CD is cancelled. According to embodiments of the invention and as indicated by block 240, possibly after determining that some information is required to be deleted from the virtual volume, the flow may include deleting such information. Such delete may be at a level such as a single file or an entire volume. According to embodiments of the invention and as indicated by the arrow connecting block 240 with block 245, possibly after deleting information from a virtual volume, information contained in the virtual volume may be encrypted. According to embodiments of the invention, sectors associated with deleted may be encrypted. According to embodiments of the invention, all sectors associated with a virtual volume may be encrypted, including sectors containing no data or information. Accordingly, after information has been deleted or otherwise removed from a virtual volume, sectors or any other blocks or structures comprising the virtual volume may be encrypted.

According to embodiments of the invention and as indicated by block 250, possibly following a deletion of information and an encryption of resulting empty sectors, such encrypted sectors may be stored in the virtual volume. According to embodiments of the invention and as indicated by block 255, an information or content parameters list described above may be updated to reflect the change applied to information stored in the virtual volume, for example, names of files deleted as shown by block 240 may be removed from the list. According to embodiments of the invention, metadata associated with the virtual volume may be stored in the list as described above, accordingly, following a delete of content or information from a virtual volume, metadata may be updated. For example, a change of size of the virtual volume that may have resulted may be recorded as shown by block 255. Accordingly, a hash parameter may be recomputed as shown by block 225. According to embodiments of the invention and as indicated by block 236, possibly if no data is required to be added to the virtual volume nor deleted from the virtual volume then the flow may terminate.

It will be noted that other manipulation of information associated with a virtual volume may be performed. For example, in a similar manner to the one described for deleting or adding content from/to a virtual volume, information stored in a virtual volume may be modified. Accordingly, encryption may be applied to modified information, and various information structures such as the information or content parameters list may be properly modified or updated. Alternatively, modifying content may comprise deleting it from the virtual volume and additionally adding a modified version to the virtual volume. It will be recognized that some operations described above may be omitted or altered. For example, in some embodiments, information may be stored in a native, unencrypted form in the virtual volume.

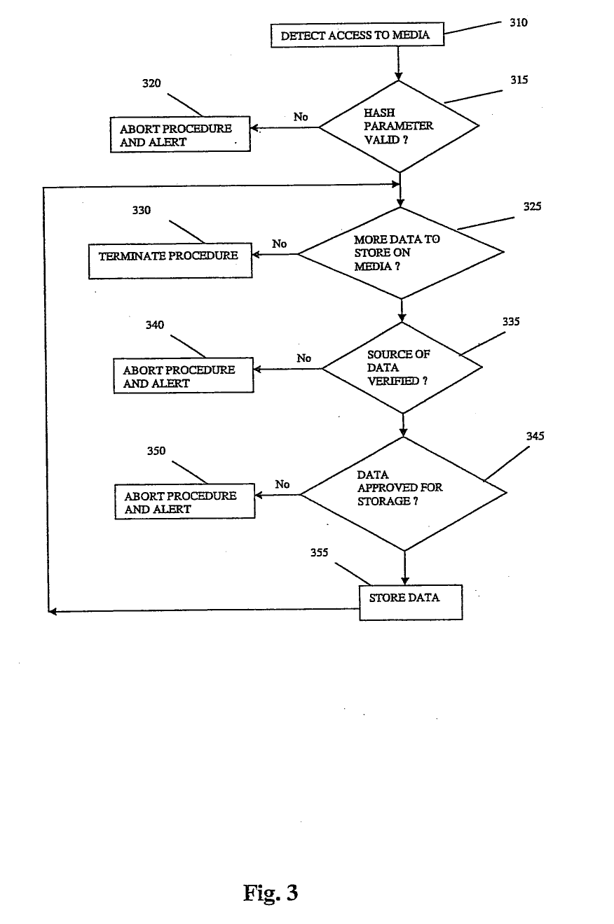

Reference is made to FIG. 3 showing an exemplary flow chart according to embodiments of the invention. According to embodiments of the invention and as indicated by block 310, the flow may include detecting an attempt to access a media. For example, media filter module 125 (FIG. 1) may detect an attempt to access a media in drive 150, such media may be a writable CD as described above. Alternatively, such media may be a detachable disk, a backup or other tape or any applicable storage media. According to embodiments of the invention, possibly if the access attempt detected involves an attempt to write to a media, a validity of a hash parameter may be verified as shown by block 315. For example, embodiments of the invention may be configured such that only data from a specific source may be written to a specific device. For example, writing or burning data onto an optical CD media in a specific drive may only be permitted if the data source is a virtual volume. Such configuration may enable an organization to enforce rules or policies that may govern storing, possibly sensitive information, on removable or other media.

According to embodiments of the invention and as indicated by block 315, the flow may include validating a hash parameter. According to embodiments of the invention, validating a hash parameter may comprise computing a hash parameter for a virtual volume and further comparing the computed hash parameter to a previously computed, stored hash parameter. Such method may verify that information stored in a virtual volume has not been modified by any entity other than a designated, authorized entity such as virtual volume driver module 130 shown in FIG. 1. According to embodiments of the invention and as shown by block 320, the flow or procedure may be aborted and/or terminated if a validation of a hash parameter fails. According to embodiments of the invention, such failure may indicate that information stored in a virtual volume (e.g., virtual volume 140) has been modified or otherwise manipulated by an unauthorized entity. Accordingly, embodiments of the invention may disable information stored in such virtual volume from being copied, transferred or burned onto a specific media such as a media installed in device 150. According to embodiments of the invention, a user may be notified, alerted or otherwise be made aware of a termination of the flow as shown by block 320. For example, a message indicating the problem may be displayed to a user and/or audible effects may be produced. Other means for informing one or more users or administrators such as electronic mail or paging systems may be utilized by embodiments of the invention.

According to embodiments of the invention and as indicated by block 325, the flow may include determining if data to be written, copied or otherwise transferred to a specific media is available. According to embodiments of the invention and as indicated by block 320, the flow may terminate if no more information to be transferred to a media is available. According to embodiments of the invention, one or more users may be made aware of such termination. According to embodiments of the invention, a termination of a copy, write or burn of information onto a media may further include storing a utility on the target or destination media. According to embodiments of the invention, such utility may be configured to extract information from the media. For example, the utility may be capable of interfacing with a specific file system according to which information is logically arranged in a volume stored on the media. Additionally, if data copied to a media is encrypted then the utility may further enable decryption of the data. For example, such utility may be configured to decrypt information upon being provided with a preconfigured password or any other suitable set of parameters or information such as user name and associated password.

According to embodiments of the invention and as indicated by block 335, the flow may include verifying and/or determining the source of the information being stored on a media or device. According to embodiments of the invention, information identifying the entity performing a store operation on a media may be obtained. For example, a process identification (process ID) may be obtained by embodiments of the invention. According to embodiments of the invention, an identification of the process may be used in order to verify that the process only reads data from a known and/or designated location. For example, media filter module 125 may obtain the process ID and/or thread ID of the process and/or thread attempting to write to a media in device 150. Media filter module 125 may further provide the obtained process and/or thread ID to file system filter module 135. According to embodiments of the invention, file system filter module 135 may verify that the process associated with the obtained ID only reads data from virtual volume 140. According to embodiments of the invention, file system filter module 135 may perform such verification by monitoring and/or intercepting access attempts to storage devices, possibly by monitoring requests made to a file system associated with storage device 145 or other storage devices and may further determine the ID of the processes associated with theses attempts.

According to embodiments of the invention, if file system filter module 135 detects that a process currently storing data on a media in device 150 is also reading information from any location other than virtual volume 140 then system filter 135 may cause the store operation to be aborted. For example, system filter 135 may inform media filter module 125 of such violation and media filter module 125 may disable access to device 150 upon being informed of the violation. For example, media filter module 125 may terminate the store procedure as shown by block 340. According to embodiments of the invention, terminating the procedure may include alerting a user as described above with reference to block 320.

According to embodiments of the invention and as indicated by block 345, the flow may include verifying and/or determining that information being stored on a storage media such as a media installed in device 150 has been designated or otherwise approved for such manipulation. According to embodiments of the invention, media filter module 125 may verify that information being written to a specific media from a specific repository or virtual volume is logged, listed or otherwise referenced in a designated location, e.g., information or content parameters list 155. According to embodiments of the invention, media filter module 125 may extract or otherwise obtain parameters pertaining to information being written to a media. Such parameters may comprise any applicable data that may be used to identify the information or content being written to a media or device such as device 150 or a media installed in device 150. For example, such parameters may be file name, size, modification date or any other, applicable attributes.

According to embodiments of the invention, media filter module 125 may compare such obtained parameters to information stored in list 155 or media filter module 125 may otherwise examine such parameters with reference to list 155 and further determine if the information may be written to the destination device such as a media installed in device 150. According to embodiments of the invention, if the information may not be written to the destination device then media filter module 125 may terminate the store procedure as shown by block 350. According to embodiments of the invention, terminating the procedure may include alerting a user as described above with reference to block 320. According to embodiments of the invention, list 155 may be stored on a removable or detachable device. According to embodiments of the invention, if media filter module 125 is not provided with list 155 it may not be able to determine that information to be stored is indeed approved for such operation. Accordingly, media filter module 125 may disable such operation and further cause the procedure to be aborted as shown by block 350.

According to embodiments of the invention, control and/or management of storage operations as described above may be centralized. According to embodiments of the invention, the hash parameter and/or information or content parameters list may be stored on a remote computer. For example, the hash parameter and/or information or content parameters list may be stored on an administrative or management computer. Accordingly, transferring information from a repository or virtual volume to a designated device or media may be disabled if the computing device is not operatively connected to the management computer since under such conditions, filter module 125 may be unable to determine that information stored in the repository is approved for such transfer. Alternatively, if the hash parameter is inaccessible at a time the computing device is booted or restarted, then verifying an integrity of information stored in the repository may fail and access to the repository may be consequently blocked. Such configuration or setup may enable embodiments of the invention to enforce various policies pertaining to transfer of information to various devices or media. Additionally, such configuration may enable an administrative and/or management entity to easily and readily manipulate information or content parameters lists and/or hash parameters or apply global rules and/or constraints. For example, an administrator may easily disable a number of computing devices from performing various operations by moving or deleting their associated hash parameters or information or content parameters lists.

According to embodiments of the invention, possibly provided above conditions are met, information may be stored on the target device as shown by block 355. For example, if the target device is an optical, writable CD then storing data as shown by block 355 may comprise burning of the information onto an optical media.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for storing information on a storage device comprising:
storing in a repository on a first storage device information identified for copying to a second storage device;
creating a list of identification parameters pertaining to at least some of the information identified for copying;
receiving a request to copy information to a second storage device; and
determining based on said list of identification parameters whether to allow or deny said request to copy information.

2. The method of claim 1, wherein said determining whether to allow or deny said request to copy information comprises determining whether information requested to be copied is referenced by said list of identification parameters.

3. The method of claim 1, further comprising allowing said request to copy information if said information is referenced by said list of identification parameters.

4. The method of claim 1, further comprising denying said request to copy information if said information is referenced by said list of identification parameters.

5. The method of claim 1, further comprising determining that an entity storing information on said second device is obtaining said information from said repository.

6. The method of claim 1, wherein said storing information in a repository further comprises computing a hash parameter and further using said hash parameter to validate an integrity of information stored in said repository.

7. The method of claim 1, wherein said storing information in said repository further comprises encrypting said information.

8. The method of claim 1, wherein said second storage device is an optical media.

9. The method of claim 1, wherein said repository is a virtual volume.

10. A system for storing information on a storage device comprising:
a first storage device to store an information repository;
an identification parameters list;
a first module to store information in said repository and to update said identification parameters list according to said store and to compute a hash parameter based on said information; and
a second module to supervise a transfer of said information to a second storage device wherein said supervise is based, at least in part, on information contained in said identification parameters list.

11. The system of claim 10 further comprising a third module to receive from said second module at least one parameter pertaining to an entity storing information on said second storage device and wherein said third module is to determine that said entity is obtaining said information from said repository.

12. The system of claim 10, further comprising a virtual file system driver to manage a virtual file system and wherein said repository is a virtual volume stored on said virtual file system.

13. The system of claim 10 wherein access to said identification parameters list and said hash parameter is restricted to designated entities.

14. The system of claim 10 wherein said hash parameter is stored on a remote computer.

15. The system of claim 10 wherein said identification parameters list is stored on a remote computer.

16. The system of claim 10 wherein said first module is further configured to validate an integrity of information stored in said repository according to said hash parameter.
